(19) United States
(12) Patent Application Publication
(10) Pub. No.: US 2026/0339317 A1
(43) Pub. Date: Oct. 29, 2026

(54) SYSTEM AND METHOD FOR AUTONOMOUS RISK-BASED MAINTENANCE OF A FACILITY

(71) Applicant: Schlumberger Technology Corporation, Sugar Land, TX (US)

(72) Inventors: Matthew Worthington, Houston, TX (US); James Neill, Houston, TX (US); Parag Vasant Karanjkar, Houston, TX (US); Yamid Pico, Houston, TX (US)

(21) Appl. No.: 19/191,017

(22) Filed: Apr. 28, 2025

(51) Int. Cl. G05B 23/02

(52) U.S. Cl. CPC G05B 23/0283; G05B 23/0229

(57) ABSTRACT

A method for autonomous risk-based maintenance of assets of a facility includes receiving input data related to each of the assets. The method also includes determining a risk rating for each of the assets based on the input data. The method also includes generating an alert for at least one of the assets based on the respective risk rating thereof and the input data. The method also includes determining a degree of the respective alert for the at least one of the assets based on the risk rating thereof and the input data. The method also includes generating a maintenance plan based on the alert for the at least one of the assets and the degree of the respective alert for the at least one of the assets.

### BACKGROUND

Conventional methods for asset management and/or maintenance of a facility, such as periodic inspections or reactive repairs, may often fail to optimize resource allocation or prevent unexpected failures. These conventional methods rely on static schedules or manual assessments that may not account for real-time equipment conditions, usage patterns, operational criticality, or the like. As a result, low-risk assets may receive unnecessary attention, while high-risk assets may be overlooked until failure occurs, thereby leading to costly downtime and avoidable safety risks.

What is needed, then, are systems and methods for automating maintenance of assets of a facility.

### SUMMARY

A method for autonomous risk-based maintenance of assets of a facility is disclosed. The method includes receiving input data related to each of the assets. The method also includes determining a risk rating for each of the assets based on the input data. The method also includes generating an alert for at least one of the assets based on the respective risk rating thereof and the input data. The method also includes determining a degree of the respective alert for the at least one of the assets based on the risk rating thereof and the input data. The method also includes generating a maintenance plan based on the alert for the at least one of the assets and the degree of the respective alert for the at least one of the assets.

A computing system is also disclosed. The computing system includes one or more processors and a method system. The method system includes one or more non-transitory computer-readable media storing instructions that, when executed by at least one of the one or more processors, cause the computing system to perform operations. The operations includes receiving input data related to each of the assets. The operations also includes determining a risk rating for each of the assets based on the input data. The operations also includes generating an alert for at least one of the assets based on the respective risk rating thereof and the input data. The operations also includes determining a degree of the respective alert for the at least one of the assets based on the risk rating thereof and the input data. The operations also includes generating a maintenance plan based on the alert for the at least one of the assets and the degree of the respective alert for the at least one of the assets.

A non-transitory computer-readable medium is also disclosed. The medium stores instructions that, when executed by one or more processors of a computing system, cause the computing system to perform operations. The operations includes receiving input data related to each of the assets. The operations also includes determining a risk rating for each of the assets based on the input data. The operations also includes generating an alert for at least one of the assets based on the respective risk rating thereof and the input data. The operations also includes determining a degree of the respective alert for the at least one of the assets based on the risk rating thereof and the input data. The operations also includes generating a maintenance plan based on the alert for the at least one of the assets and the degree of the respective alert for the at least one of the assets.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for automating risk-based maintenance of assets of a facility, according to an embodiment.

FIG. 3 illustrates an exemplary risk matrix for a plurality of assets based on the PoF and the CoF for each of the assets, according to an embodiment.

FIG. 4 illustrates an exemplary knowledge graph of the assets of a facility including a plurality of nodes or vertices and a plurality of edges, according to an embodiment.

FIG. 5 illustrates an exemplary flowchart or workflow of an AI agent for generating the maintenance plan, according to an embodiment.

FIG. 6 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

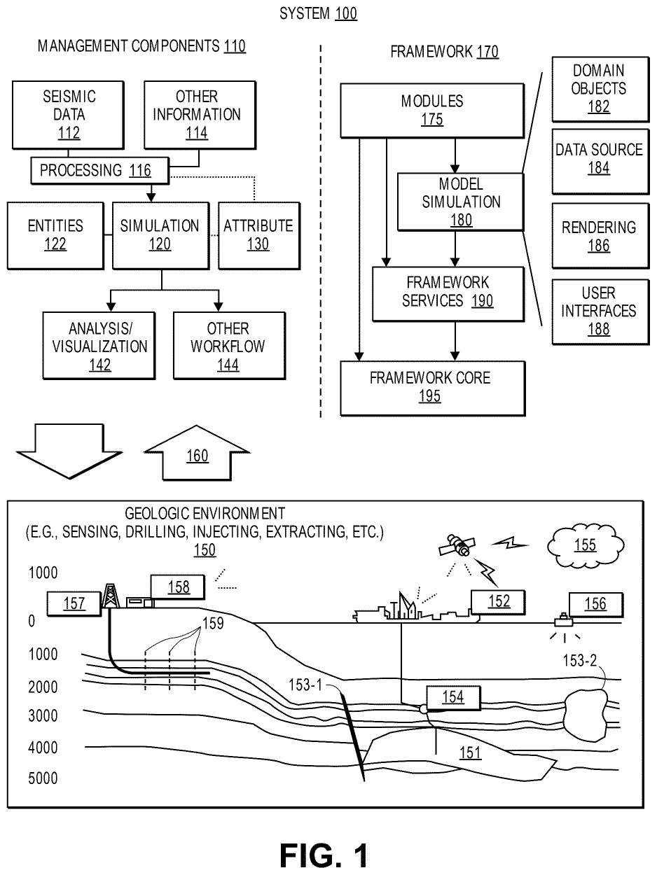

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY software (SLB, Houston, Texas). More particularly, SYMMETRY may process workflows in a single integrated environment with accurate thermodynamic fluid representation and consistent modeling across multiple disciplines including process, production, and HSE. The simulator integrates steady-state and transient (e.g., dynamic) analyses that can be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM (SLB, Houston, Texas). More particularly, PIPESIM is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

The present disclosure includes autonomous or semiautonomous systems and methods for automating monitoring and/or maintenance of assets of a facility. The systems and methods for monitoring and/or maintenance of the assets of the facility may generally utilize integrated data sources, predictive analytics, decision logic, or the like, or any combination thereof to dynamically and/or iteratively assess asset health, prioritize maintenance actions, generate or trigger appropriate intervention without or with minimal manual oversight. The systems and methods disclosed herein may generally improve efficiency of the monitoring and/or maintenance of the assets of the facility, reduce operational disruptions (e.g., downtime, etc.), improve long-term reliability of assets, or any combination thereof. While the present disclosure may make references to oil and gas facilities and/or oil and gas assets thereof, it should be appreciated that the systems and methods disclosed herein may be equally applicable to other facilities unrelated to oil and gas, and respective assets thereof. Illustrative facilities and/or industries in which the systems and methods may be applicable may be or include, but are not limited to, oil and gas, healthcare, manufacturing, power generation, or the like, or any combination thereof.

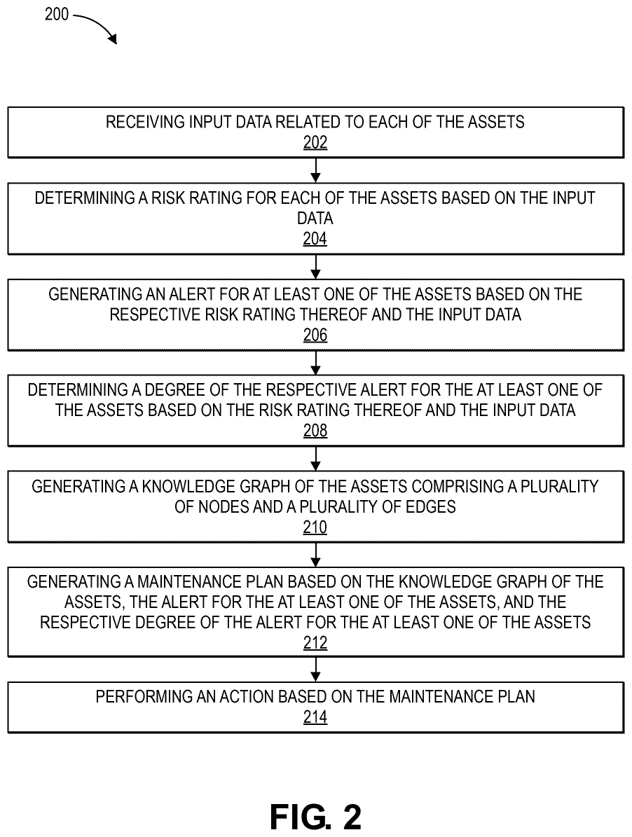

FIG. 2 illustrates a flowchart of a method 200 for automating risk-based maintenance of assets of a facility, according to one or more embodiments disclosed herein. An illustrative order of the method 200 is provided below; however, one or more portions of the method 200 may be performed in a different order, simultaneously, repeated, or omitted. At least a portion of the method 200 may be performed using a computing system.

The method 200 for automating risk-based maintenance of assets of the facility may include receiving input data related to each of the assets, as at 202. As noted above, the facility and the assets thereof may be or include, but are not limited to, those related to oil and gas, healthcare, manufacturing, power generation, or the like, or any combination thereof. Accordingly, the facility may be or include an oil and gas facility, a manufacturing facility, a power generation facility, a healthcare facility, or the like, or any combination thereof. The assets may include, but are not limited to, one or more of oil and gas assets, manufacturing assets, power generation assets, healthcare assets, or the like, or any combination thereof. As used herein, the term or expression “asset” may refer to or include a physical object, a physical equipment, a logical system of the equipment, a system, a subsystem, an entire facility, a component thereof, or the like, or any combination thereof. For example, the term “asset” may not be limited to a single piece of equipment, but may refer to a subsystem of the facility or a group of assets of the facility, such as a subsystem including a plurality of assets having one or more shared functions and/or modes of operation.

The input data related to each of the assets may be or include, but are not limited to, one or more of data or information from a subject matter expert (SME) of the facility for each of the assets, a respective digital twin of each of the assets, a respective predictive maintenance data for each of the assets, or any combination thereof. The respective digital twin of each of the assets may be a virtual representation of the asset. The digital twin may integrate data from one or more sources, including, but not limited to, data from sensors monitoring the respective asset, historical records of the respective asset, operational models of the respective asset, performance of the respective asset, or the like, or any combination thereof. The digital twin may include real-time data, simulation or predicted data, lifecycle data, or the like, or any combination thereof. Illustrative input data related to the digital twin of each of the assets may include, but is not limited to, one or more of a respective age thereof, a respective operational condition thereof, a respective maintenance record/history thereof, a respective historical failure thereof, a respective safety risk due to failure thereof, a respective environmental consequence due to failure thereof, a respective financial cost due to failure thereof, a respective production loss due to failure thereof, a respective operational function thereof, or any combination thereof. In at least one embodiment, the digital twin of each of the assets may further include the data from the subject matter expert (SME) of the facility for each of the assets, the respective predictive maintenance data for each of the assets, or any combination thereof. In at least one embodiment, the input data related to each of the assets and/or the digital twin thereof may also be or include a process diagram of the facility, a process workflow of the facility, or the like, or any combination thereof. For example, the input data may also include one or more process flow diagrams of the facility, which may include information/data related to process equipment of the facility, process flow paths of the facility, control loops of the facility, or the like, or any combination thereof. In another example, the input data may include one or more piping and instrumentation diagrams (P&ID) of the facility.

The data from the subject matter expert (SME) may be domain-specific data related to the development, operation, and/or optimization of processes and systems of the facility. For example, the data from the SME or the SME data may include operational data, maintenance data, process knowledge, design intent and/or engineering constraints, data related to the digital twin, asset criticality, or the like, or any combination thereof. In an exemplary embodiment, the data from the SME includes a respective asset criticality of each of the assets of the facility. For example, the SME may provide the respective asset criticality of each of the assets of the facility based on the domain-specific data related to the development, operation, and/or optimization of processes and systems of the facility. As used herein, the term or expression “asset criticality” in relation to data from the SME may refer to a measure (e.g., a relative measure) of how important the asset is with respect to other assets and/or to the facility, a system thereof, a subsystem thereof, or any combination thereof. The asset criticality may reflect, include, relate to, or otherwise incorporate one or more of institutional knowledge of the SME, domain-specific data, the aforementioned input data, or any combination thereof. The asset criticality may be defined or reflected as a value, such as a numerical value. The numerical value may be within a predetermined scale or range of numerical values (e.g., 1 to 10, 1 to 100, etc.).

As noted above, the input data may include predictive maintenance data for each of the assets. As used herein, the term or expression “predictive maintenance data” may refer to information/data, such as measurable information/data, collected and/or analyzed to anticipate failure before it occurs. Sources of determining and/or generating the predictive maintenance data may be or include, but are not limited to, real-time and/or historical sensor data, operational data (e.g., run-times, cycles info, etc.), historical failure data, environmental data, the aforementioned input data, condition monitoring tools, root cause analysis (RCA), or the like, or any combination thereof. Illustrative condition monitoring tools may be or include, but are not limited to one or more of vibration analysis, thermography, ultrasonic testing, or the like, or any combination thereof. The condition monitoring tools may be configured to predict equipment failures. The RCA may be configured to investigate underlying causes of failures to prevent recurrences. The predictive maintenance data may be generated with an artificial intelligence (AI) model. For example, the AI model may receive data from one or more of the sources for determining and/or generating the predictive maintenance data, and generate an output. The AI model may be or include a machine-learning (ML) model, such as a trained ML model. The output from the AI model may anticipate failure of the asset based on the data received from one or more of the sources, such may include at least a portion of the input data. The output from the AI model or the predictive maintenance data may be or include, but is not limited to, one or more of a health score/index of the asset, a remaining useful life (RUL) of the asset, a failure risk probability of the asset, a maintenance recommendation of the asset, a confidence score of the asset, or the like, or any combination thereof.

The method 200 for automating risk-based maintenance of assets of the facility may include determining a risk rating for each of the assets based on the input data, as at 204. The risk rating for each of the assets may be based on at least a portion of the input data. In at least one embodiment, the risk rating may be based on the respective digital twin of each of the assets of the input data. In at least one embodiment, the risk rating for each of the assets may be determined, at least in part, by evaluating at least a portion of the input data with one or more of data analytics, mathematical models, a machine-learning (ML) model, such as a risk-rating machine-learning model, maintenance schedules, or any combination thereof. For example, the risk rating may be determined by evaluating the respective digital twin of each of the assets with one or more of the data analytics, the mathematical models, the risk-rating ML model, the maintenance schedules thereof, or any combination thereof. The risk rating may be based on a respective probability of failure (PoF) for each of the assets, a respective consequence of failure (CoF) or severity for each of the assets, or a combination thereof. As used herein, the term or expression “probability of failure” (PoF) or the like may refer to the likelihood that the respective asset may fail. The PoF may consider, be related to, or be based on one or more factors including, but not limited to, the respective age of the asset, the respective historical failure of the asset, the respective operational condition of the asset, the respective maintenance record or history of the asset, or any combination thereof. The PoF of each of the assets may be represented as a numerical value defined by the one or more factors. For example, the PoF of each of the assets may be represented as a numerical value on a scale or range of numerical values based on one or more of the aforementioned factors. As used herein, the term or expression “consequence of failure” (CoF), severity, or the like, may refer to a measure of the potential impact of a failure. The consequence of failure may consider, be related to, or be based on one or more factors including, but not limited to, the respective safety risk due to failure of the asset, the respective environmental consequence due to failure of the asset, the respective financial cost due to failure of the asset, the respective production loss due to failure of the asset, or any combination thereof. The CoF of each of the assets may be represented as a numerical value defined by the one or more factors. For example, the CoF of each of the assets may be represented as a numerical value on a scale or range of numerical values based on one or more of the aforementioned factors.

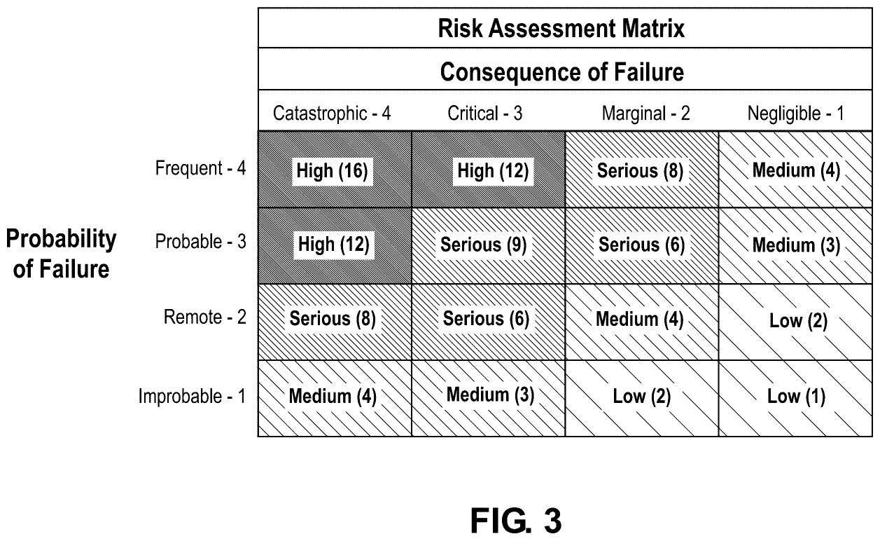

As discussed above, the risk rating of each of the assets may be based on the respective probability of failure, the respective consequence of failure, or any combination thereof. In at least one embodiment, the risk rating for each of the assets may be based on both the respective probability of failure and the respective consequence of failure. For example, the risk rating may be determined by generating a risk matrix based on the PoF for each of the assets and a CoF for each of the assets. FIG. 3 illustrates an exemplary risk matrix for a plurality of assets based on the PoF and the Cof for each of the assets, according to one or more embodiments disclosed herein. As noted above, each of the PoF and the CoF may be represented by a numerical value. The numerical values of each of the PoF and the CoF may be plotted on the risk matrix to determine the risk rating thereof. As illustrated in FIG. 3, the respective numerical value of the PoF may be plotted along the columns of the risk matrix and the respective numerical value of the CoF may be plotted along the rows of the risk matrix. While the numerical values of the CoF in FIG. 3 are associated with particular categories and/or designations, such as catastrophic, critical, marginal, and negligible, it should be appreciated that other categories and/or designations are contemplated. Similarly, while the numerical values of the PoF in FIG. 3 are associated with particular categories/designations, such as improbably, remote, probably, and frequent, it should be appreciated that other categories and/or designations are contemplated. As illustrated in FIG. 3, plotting the CoF and the PoF of each of the assets in the risk matrix may provide the respective risk rating of each of the asset. For example, based on the risk matrix of FIG. 3, an asset having a frequent PoF and a catastrophic CoF may have a “high” risk rating.

The method 200 for automating risk-based maintenance of assets of the facility may include generating an alert for at least one of the assets based on the respective risk rating thereof and the input data, as at 206. For example, the method 200 may include generating the alert for the at least one of the assets based on the respective risk rating thereof and the respective data from the SME of the facility. As noted above, the data from the SME of the facility may include the asset criticality of the asset. Accordingly, the method 200 may include generating the alert for the at least one of the assets based on the respective risk rating thereof and the asset criticality thereof. The alert may be generated autonomously, semi-autonomously, or manually. For example, the risk rating and the asset criticality may be evaluated with one or more of data analytics, mathematical models, ML models, or the like, or any combination thereof to generate the alert. The alert may indicate the presence of an issue with the asset and/or the degree of the issue with the asset. In at least one embodiment, the alert indicates at least the presence of an issue with the asset, thereby directing attention to the asset.

The method 200 for automating risk-based maintenance of assets of the facility may include determining a degree of the respective alert for the at least one of the assets based on the respective risk rating thereof and the input data, as at 208. For example, the degree of the alert may be based on the respective risk rating of the asset and at least a portion of the input data. In at least one embodiment, the risk rating may be based on a combination of the risk rating of the asset and one or more of the operational function of the asset, the asset criticality of the asset (i.e., the data from the SME), the predictive maintenance of the asset, or any combination thereof. The degree of the respective alert may be determined by evaluating the respective risk rating of the asset and the input data. The degree of the alert may be determined autonomously, semi-autonomously, or manually. For example, the risk rating of the asset and the input data may be evaluated with one or more of data analytics, mathematical models, ML models, or the like, or any combination thereof to determine the degree of the alert. The levels of the respective alert may include, but are not limited to, low, medium, high, or the like. It should be appreciated, however, that other levels of the alert are contemplated.

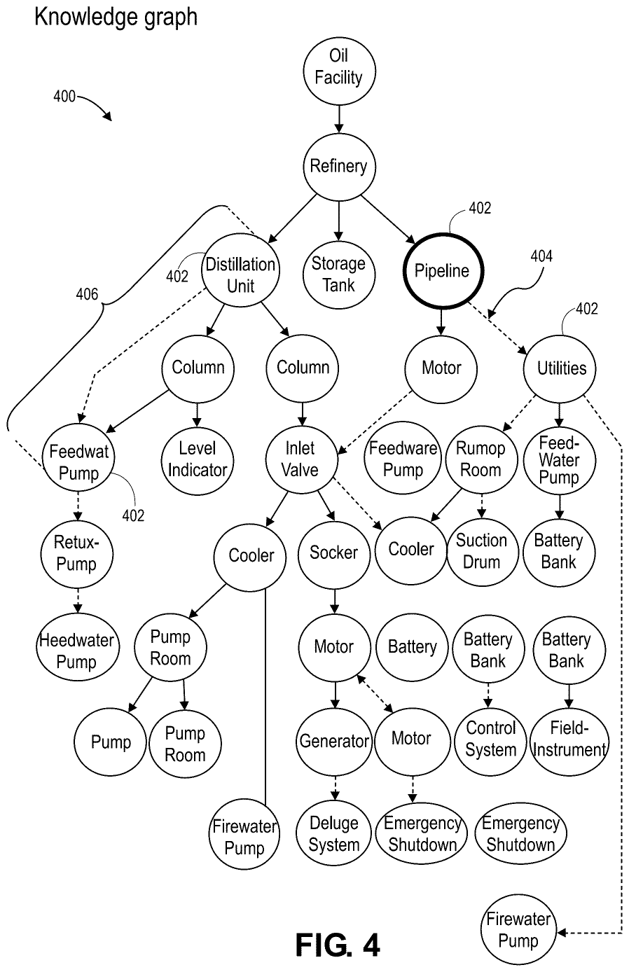

The method 200 for automating risk-based maintenance of assets of the facility may also include generating a knowledge graph of the assets including a plurality of nodes and a plurality of edges, as at 210. FIG. 4 illustrates an exemplary knowledge graph 400 of the assets of a facility including a plurality of nodes or vertices 402 and a plurality of edges 404, according to one or more embodiments disclosed. The knowledge graph 400, and plurality of nodes 402 and edges 404 thereof, may be generated or determined based on at least a portion of the input data related to each of the respective assets. Each of the nodes 402 may represent one of the assets of the facility. For example, as illustrated in FIG. 4, the nodes 402 may represent a pipeline, a distillation unit, a feed-water pump, or the like. While FIG. 4 illustrates each of the nodes 402 as representing a particular piece of equipment, it should be appreciated, as noted above, that the asset may also include a single piece of equipment, a subsystem, a group of assets, a facility, or the like. Accordingly, any one or more of the nodes 402 may also represent a subsystem, a group of equipment, a facility, a logical system of equipment, or the like. Each of the edges 404, represented as an arrow (e.g., hashed and solid), may represent a link or relationship between two or more nodes. For example, as illustrated in FIG. 4, one of the edges 404 may represent the relationship between the node 402 for the distillation unit and the node 402 for the feedwater pump.

The combination of two nodes 402 and the respective edge 404 coupling the two nodes 402 may be referred to as a triple 406, as illustrated in FIG. 4. The relationship between the two respective nodes may be determined or based on one or more of the process diagram of the facility, the process workflow of the facility (e.g., P&ID, PFD, etc.), a natural language processing (NLP) technique, a machine-learning model (e.g., trained ML model), or the like, or any combination thereof. For example, at least a portion of the input data may be evaluated with via the NLP technique, the ML-model, or the like, or any combination thereof to determine the edges 404, and thus, the relationship, between two or more assets or nodes 402. In at least one embodiment, the knowledge graph 400 may incorporate, integrate, or otherwise include domain-specific constraints related to any one or more of the assets or nodes 402. For example, the knowledge graph 400 may include rules, limitations, conditions, or the like, that apply to the particular facility, the assets thereof, or the like, or any combination thereof. The domain-specific constraints may be represented by the nodes 402, the edges 404, or any combination thereof. For example, the domain-specific constraints may be represented explicitly via the nodes 402 and the edges 404 coupling the respective nodes. In another example, any one or more of the nodes 402 may include node properties or metadata including attributes or tags that may reflect constraints of the respective asset. In yet another example, the domain-specific constraints may be or include relationship dependencies, data type restrictions, value ranges, or the like, or any combination thereof.

The method 200 for automating risk-based maintenance of assets of the facility may include generating a maintenance plan based on the knowledge graph 400 of the assets, the alerts for the at least one of the assets, the respective degree of the alert for the at least one of the assets, as at 212. The maintenance plan may include one or more task. The one or more tasks may be categorized as preventative maintenance, corrective maintenance, or a combination thereof. Preventative maintenance may be or include activities or tasks to prevent failure of the asset. For example, the preventative maintenance may include scheduled maintenance activities based on time and/or usage of the asset to prevent failures thereof. Corrective maintenance may be or include activities or tasks to address issues or failures after they arise.

In at least one embodiment, generating the maintenance plan based on the knowledge graph 400 and the alerts for the at least one of the assets may include identifying the node 402 associated with the at least one of the assets having the alert with the knowledge graph 400. Generating the maintenance plan may also include directing the alert for the at least one of the assets to a large language model (LLM), and evaluating the knowledge graph 400 and the alert to determine the node 402 associated with the at least one of the assets with the alert. Generating the maintenance plan may also include identifying one or more triples 406 related to the identified node 402. The one or more triples may be identified with a Retrieval-Augmented Generation (RAG). RAG may be an artificial intelligence technique that may combine retrieval of information, such as external information, with text generation. RAG may be capable of or configured to enable language models to produce or generate relatively more accurate and content-aware responses. For example, the RAG may enhance the LLM by retrieving relevant documents or data from a knowledge base and/or the input data, and generate a grounded response or output. Generating the maintenance plan may also include retrieving the domain-specific constraints (e.g., from the knowledge graph 400) related to the at least one of the assets associated with the identified node 402. Generating the maintenance plan may also include directing the degree of the respective alert, which is related to or based on the asset criticality of the asset, to the LLM. In at least one embodiment, generating the maintenance plan may include generating the maintenance plan with the LLM based on the alert for the at least one of the assets, the degree of the respective alert, the one or more identified triples 406, the domain-specific constraints, or any combination thereof. The LLM may, either alone or in combination with RAG or another tool, prioritize the tasks of the maintenance plan based on the alert of the at least one of the assets, the degree of the respective alert, the one or more identified triples, the domain-specific constraints, or any combination thereof. It should be appreciated that the degree of the respective alert may be related to the asset criticality of the asset, as partially determined by the SME of the facility. Accordingly, it should be appreciated that the maintenance plan and/or the LLM generating the maintenance plan may consider or be based on not only the knowledge graph, but may also consider a combination of the alert, the degree of the alert (e.g., the asset criticality), and/or the knowledge graph 400.

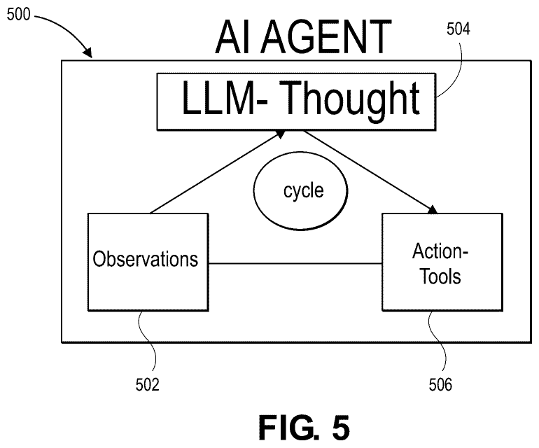

FIG. 5 illustrates an exemplary flowchart or workflow of an AI agent 500 for generating the maintenance plan, according to one or more embodiments disclosed. The AI agent 500, such as the LLM, may request information and/or information may be directed to the AI agent 500. For example, the knowledge graph 400, the alert generated from the digital twin, the degree of the alert related to the asset criticality, or any combination thereof, may be directed to the AI agent 500. The AI agent 500 may receive the information as observations 502. The AI agent 500 may evaluate the information or observations 502 via a LLM thought process 504 to generated the maintenance plan. For example, the AI Agent 500 may generate the maintenance plan by determining one or more of the following: which one of the assets have a high probability of failure, what assets have a remaining useful life (RUL) of a predetermined amount of days (e.g., 30 days, etc.), which assets have relatively higher consequence of failure due to the asset criticality or the degree of the alert and/or the risk rating, which assets have repairs initiated, or the like, or any combination thereof. The AI agent 500 may generate the maintenance plan with action tools 506. For example, the AI agent 500 may generate orders or action with the action tools 506 based on the evaluation at the LLM thought process 504. For example, the AI agent 500 may create repair orders, assign priority of the repair orders, update alerts, direct an autonomous or semiautonomous agent (e.g., robot) or person to conduct an inspection, or the like, or any combination thereof. The AI agent 500 in generating the maintenance plan and/or assigning priority of the repair orders may consider the risk matrix, the risk rating, the asset criticality, the alert, the knowledge graph, or any combination thereof. As illustrated in FIG. 5, the flowchart or the workflow for the AI agent 500 may be cyclic or iterative. Accordingly, the AI agent 500 may receive or request updated information, such as any updated alerts generated from the digital twin, the updated degree of the alert, updated information from the knowledge graph 400, or any combination thereof, and generate an updated maintenance plan based on the updated information. The AI agent 500 may operate autonomously or semi-autonomously.

The method 200 for automating risk-based maintenance of assets of the facility may include performing an action based on or in response to the maintenance plan, as at 214. The action may be or include generating and/or transmitting a signal that recommends, instructs, or causes a physical action to occur. The action may also or instead include performing the physical action. The physical action may include implementing the maintenance plan. For example, the action may include implementing or initiating the maintenance plan generated by the AI agent 500 or the LLM thereof. Implementing or initiating the maintenance plan may include one or more of: autonomously creating a maintenance order and/or a repair order based on the maintenance plan, autonomously assigning the maintenance order and/or the repair order based on the maintenance plan, or any combination thereof. The action may also include autonomously generating a summary including results of implementing the maintenance plan. The action may further include autonomously reviewing the summary including the results of implementing the maintenance plan. The action may also include autonomously allocating maintenance resources based on the maintenance plan. Allocating maintenance resources may be or include ensuring maintenance teams, tools, and budgets align with the tasks of the maintenance plan.

In at least one embodiment, the method 200 may also include displaying any one or more of the risk rating, the alert, the degree of the respective alert, the knowledge graph, the maintenance plan, or any combination thereof. For example, the method 200 may include displaying one or more of the risk rating, the alert, the degree of the respective alert, the knowledge graph, the maintenance plan, or any combination thereof on a display, a monitor, or a user interface for a user or an operator.

As noted above, the workflow of the AI agent 500 may be iterative. Accordingly, the AI agent 500 may continuously update and/or receive updated information, such as updated/new alerts, updated/new degree of the alerts, updated status of repair and/or maintenance orders, or the like, evaluate the updated information with the LLM thought process 504, and generate updated actions with the action tools 506. As such, in at least one embodiment, the method 200 may include one or more or: receiving updated input data related to each of the assets after initiating the action based on the maintenance plan, determining an updated risk rating for each of the assets based on the updated input data, generating an updated alert for the at least one of the assets, generating a new alert for at least another one of the assets, determining a degree of the updated alert and/or the new alert based on the updated risk rating thereof and the input data; generating an updated maintenance plan based on the knowledge graph, the updated alert, the degree of the updated alert, the degree of the new alert, or any combination thereof.

### Exemplary Computing System

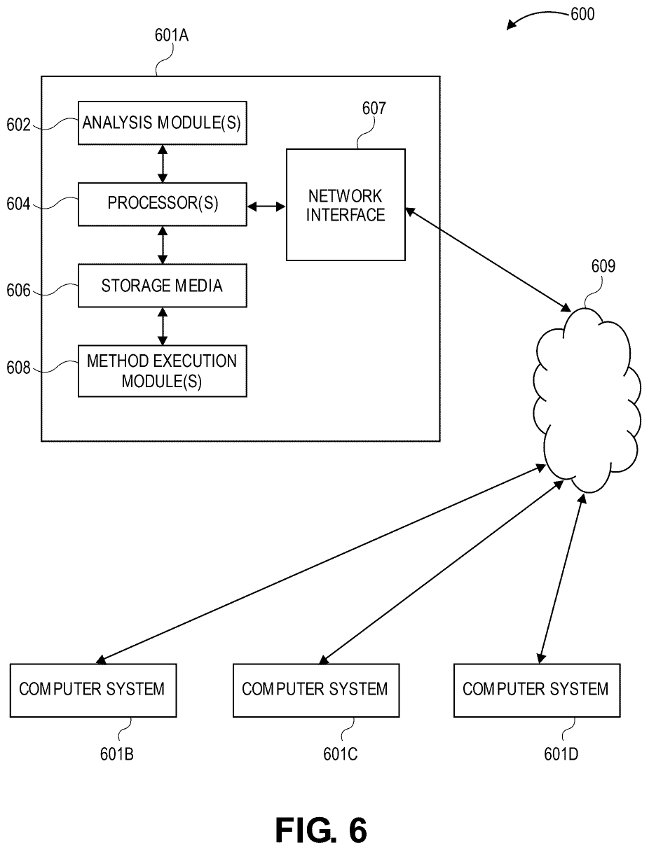

In some embodiments, the methods of the present disclosure may be executed by a computing system. FIG. 6 illustrates an example of such a computing system 600, in accordance with some embodiments. The computing system 600 may include a computer or computer system 601A, which may be an individual computer system 601A or an arrangement of distributed computer systems. The computer system 601A includes one or more analysis modules 602 that are configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor may include a microprocessor, microcontroller, processor module or subsystem, programmable integrated circuit, programmable gate array, or another control or computing device.

The storage media 606 may be implemented as one or more computer-readable or machine-readable storage media. Note that while in the example embodiment of FIG. 6 storage media 606 is depicted as within computer system 601A, in some embodiments, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 600 contains one or more method execution module(s) 608. In the example of computing system 600, computer system 601A includes the method execution module 608. In some embodiments, a single method execution module may be used to perform some aspects of one or more embodiments of the methods disclosed herein. In other embodiments, a plurality of method execution modules may be used to perform some aspects of methods herein.

It should be appreciated that computing system 600 is merely one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 600, FIG. 6), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for autonomous risk-based maintenance of assets of a facility, the method comprising:
receiving input data related to each of the assets;
determining a risk rating for each of the assets based on the input data;
generating an alert for at least one of the assets based on the respective risk rating thereof and the input data;
determining a degree of the respective alert for the at least one of the assets based on the risk rating thereof and the input data; and
generating a maintenance plan based on the alert for the at least one of the assets and the degree of the respective alert for the at least one of the assets.

2. The method of claim 1, further comprising:
generating a knowledge graph based on the assets of the facility, wherein the knowledge graph comprises a plurality of nodes and a plurality of edges, and wherein the maintenance plan is also generated based upon the knowledge graph;
receiving updated input data related to each of the assets after initiating an action based on the maintenance plan;
determining an updated risk rating for each of the assets based on the updated input data; and
generating an updated alert for the at least one of the assets based on the updated risk rating thereof and the updated input data.

3. The method of claim 2, further comprising:
determining a degree of the updated alert based on the updated risk rating thereof and the updated input data; and
generating an updated maintenance plan based on the knowledge graph, the updated alert, and the degree of the updated alert.

4. The method of claim 1, wherein the input data related to each of the assets comprises one or more of data from a subject matter expert (SME) of the facility for each of the assets, a respective digital twin of each of the assets, a respective predictive maintenance for each of the assets, or any combination thereof.

5. The method of claim 4, wherein the respective digital twin of each of the assets comprises one or more of an age thereof, an operational condition thereof, a maintenance record thereof, a historical failure thereof, a safety risk due to failure thereof, an environmental consequence due to failure thereof, a financial cost due to failure thereof, a production loss due to failure thereof, an operational function thereof, or any combination thereof.

6. The method of claim 4, wherein the data from the subject matter expert (SME) comprises an asset criticality of each of the assets with respect to the facility; and wherein the predictive maintenance for each of the assets is determined with an artificial intelligence (AI) model.

7. The method of claim 1, wherein generating the maintenance plan comprises:
generating a knowledge graph based on the assets of the facility, wherein the knowledge graph comprises a plurality of nodes and a plurality of edges, and wherein the maintenance plan is also generated based upon the knowledge graph;
directing the alert for the at least one of the assets to a large language model (LLM);
identifying, with the knowledge graph, a node of the plurality of nodes associated with the at least one of the assets; and
generating the maintenance plan with the LLM based on the knowledge graph, the alert for the at least one of the assets, the degree of the respective alert, and the identified node.

8. The method of claim 7, wherein the LLM prioritizes tasks of the maintenance plan based on the knowledge graph, the alert for the at least one of the assets, the degree of the respective alert, and the identified node.

9. The method of claim 1, further comprising performing an action based on the maintenance plan, wherein performing the action based on the maintenance plan comprises implementing the maintenance plan, wherein implementing the maintenance plan comprises autonomously creating a maintenance order based on the maintenance plan and autonomously assigning the maintenance order.

10. The method of claim 1, wherein the method is an iterative method.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data related to assets of a facility;
determining a risk rating for each of the assets based on the input data;
generating an alert for at least one of the assets based on the respective risk rating thereof and the input data;
determining a degree of the respective alert for the at least one of the assets based on the risk rating thereof and the input data;
generating a maintenance plan based on the alert for the at least one of the assets and the degree of the respective alert for the at least one of the assets.

12. The computing system of claim 11, wherein the input data related to the assets of the facility comprises one or more of data from a subject matter expert (SME) of the facility for each of the assets, a respective digital twin of each of the assets, a respective predictive maintenance for each of the assets, or any combination thereof, wherein:
the respective digital twin of each of the assets comprises one or more of an age thereof, an operational condition thereof, a maintenance record thereof, a historical failure thereof, a safety risk due to failure thereof, an environmental consequence due to failure thereof, a financial cost due to failure thereof, a production loss due to failure thereof, an operational function thereof, or any combination thereof;
the data from the subject matter expert (SME) comprises an asset criticality of each of the assets with respect to the facility; and
the predictive maintenance for each of the assets is determined with an artificial intelligence (AI) model.

13. The computing system of claim 11, wherein determining the risk rating comprises generating a risk matrix based on a respective probability of failure (PoF) for each of the assets and a respective consequence of failure (CoF) for each of the assets.

14. The computing system of claim 11, wherein:
the input data comprises one or more of data from a subject matter expert (SME) of the facility for each of the assets, a respective digital twin of each of the assets, and a respective predictive maintenance for each of the assets, wherein the data from the SME of the facility comprises an asset criticality of each of the assets with respect to the facility, and wherein the respective digital twin of each of the assets comprises a respective operational function thereof; and
the degree of the respective alert for the at least one of the assets is based on the respective risk rating thereof, the respective operational function thereof, the respective asset criticality thereof, and the respective predictive maintenance thereof.

15. The computing system of claim 11, further comprising:
generating a knowledge graph based on the assets of the facility, wherein the knowledge graph comprises a plurality of nodes and a plurality of edges, and wherein the maintenance plan is also generated based upon the knowledge graph; and
performing an action based on the maintenance plan,
wherein generating the maintenance plan comprises:
directing the alert for the at least one of the assets to a large language model (LLM);
identifying, with the knowledge graph, a node of the plurality of nodes associated with the at least one of the assets;
identifying one or more triples related to the identified node with Retrieval-Augmented Generation (RAG);
retrieving, from the knowledge graph, domain-specific constraints related to the at least one of the assets associated with the identified node; and
generating the maintenance plan with the LLM based on the alert for the at least one of the assets, the one or more identified triples, the domain-specific constraints, the degree of the respective alert, or any combination thereof.

16. A non-transitory computer-readable medium storing instructions that, when executed by one or more processors of a computing system, cause the computing system to perform operations, the operations comprising:
receiving input data related to assets of a facility;
determining a risk rating for each of the assets based on the input data;
generating an alert for at least one of the assets based on the respective risk rating thereof and the input data;
determining a degree of the respective alert for the at least one of the assets based on the risk rating thereof and the input data; and
generating a maintenance plan based on the alert for the at least one of the assets and the degree of the respective alert for the at least one of the assets.

17. The non-transitory computer-readable medium of claim 16, wherein:
the assets comprise one or more of oil and gas assets, manufacturing assets, power generation assets, healthcare assets, or any combination thereof; and
the input data related to the assets of the facility comprises one or more of data from a subject matter expert (SME) of the facility for each of the assets, a respective digital twin of each of the assets, a respective predictive maintenance for each of the assets, or any combination thereof;
wherein the respective digital twin of each of the assets comprises one or more of an age thereof, an operational condition thereof, a maintenance record thereof, a historical failure thereof, a safety risk due to failure thereof, an environmental consequence due to failure thereof, a financial cost due to failure thereof, a production loss due to failure thereof, an operational function thereof, or any combination thereof;
wherein the data from the subject matter expert (SME) comprises an asset criticality of each of the assets with respect to the facility; and
wherein the predictive maintenance for each of the assets is determined with an artificial intelligence (AI) model, wherein the AI model is configured to anticipate failure based on at least a portion of the input data, and wherein the AI model comprises a trained ML model.

18. The non-transitory computer-readable medium of claim 17, wherein the risk rating is based on a respective probability of failure (PoF) for each of the assets and a respective consequence of failure (CoF) for each of the assets, wherein:
the PoF of each of the assets is based on one or more of the respective age thereof, the respective operational condition thereof, the respective maintenance record thereof, the respective historical failure thereof, or any combination thereof;
the CoF of each of the assets is based on one or more of the respective safety risk due to failure thereof, the respective environmental consequence due to failure thereof, the respective financial cost due to failure thereof, the respective production loss due to failure thereof, or any combination thereof; and
determining the risk rating comprises generating a risk matrix based on the PoF for each of the assets and the CoF for each of the assets.

19. The non-transitory computer-readable medium of claim 18, further comprising:
generating a knowledge graph based on the assets of the facility, wherein the knowledge graph comprises a plurality of nodes and a plurality of edges, wherein the knowledge graph comprises domain-specific constraints related to each of the assets, and wherein the maintenance plan is also generated based upon the knowledge graph;
wherein:
the alert for the at least one of the assets is based on the respective risk rating thereof and the respective data from the SME of the facility;
the degree of the respective alert is based on the respective risk rating, the respective operational function thereof, the respective asset criticality thereof, the respective predictive maintenance thereof, or any combination thereof;
the maintenance plan comprises tasks selected from preventative maintenance, corrective maintenance, or a combination thereof; and
generating the maintenance plan comprises:
directing the alert for the at least one of the assets to a large language model (LLM);
identifying, with the knowledge graph, a node of the plurality of nodes associated with the at least one of the assets;
identifying one or more triples related to the identified node with Retrieval-Augmented Generation (RAG);
retrieving, from the knowledge graph, the domain-specific constraints related to the at least one of the assets associated with the identified node; and
generating the maintenance plan with the LLM based on the alert for the at least one of the assets, the degree of the respective alert, the one or more identified triples, and the domain-specific constraints, wherein the LLM prioritizes the tasks of the maintenance plan based on the alert for the at least one of the assets, the degree of the respective alert, the one or more identified triples, and the domain-specific constraints.

20. The non-transitory computer-readable medium of claim 16, wherein the operations further comprise:
performing an action based on the maintenance plan, wherein performing the action comprises:
implementing the maintenance plan;
autonomously generating a summary comprising results of implementing the maintenance plan;
autonomously reviewing the summary; and
autonomously allocating maintenance resources based on the maintenance plan.
receiving updated input data related to each of the assets after initiating the action based on the maintenance plan;
determining an updated risk rating for each of the assets based on the updated input data;
generating an updated alert for the at least one of the assets based on the updated risk rating thereof and the updated input data;
determining a degree of the updated alert based on the updated risk rating thereof and the updated input data; and
generating an updated maintenance plan based on the updated alert and the degree of the updated alert.
